(19) United States
(12) Patent Application Publication
(10) Pub. No.: US 2001/0011944 A1
(43) Pub. Date: Aug. 9, 2001

(54) Card validating apparatus

(76) Inventors: Enrique Garrido-Gadea, High Wycombe (GB); Gareth Alexander Richards, Farrington Gurney (GB)

Correspondence Address: Frank Chau, Suite 501, 1900 Hempstead Turnpike, East Meadow, NY, 11554, US

(21) Appl. No.: 09/778,260

(22) Filed: Feb. 7, 2001

(30) Foreign Application Priority Data
Feb. 7, 2000 (GB) 0002742.5

(51) Int. Cl. H04Q 1/00

(52) U.S. Cl. 340/5.86; 235/380

(57) ABSTRACT

An apparatus for validating chip cards, which also have a magnetic stripe, comprises a magnetic stripe reader and a chip card reader. The outputs of the readers for a card are compared and, if they agree, the user is informed that the card is valid.

### FIELD OF THE INVENTION

The present invention relates to a card validating apparatus.

### BACKGROUND TO THE INVENTION

Conventionally, credit and debit cards have carried data on a magnetic stripe. These magnetic stripes are prone to having their data wiped by magnetic fields in the environment. Furthermore, they are easy for fraudsters to read, enabling them to clone cards. A variation of card cloning is where a genuine card is reprogrammed with data from another card which is returned to its owner. This data may also be obtained from discarded receipts and electronic transaction data. As a consequence, when the reprogrammed card is used, the account debited in accordance with the data in the magnetic stripe is not the account for which the reprogrammed card was originally issued.

Banks and financial institutions are currently in the process of replacing conventional credit and debit card with chip cards in which the data in stored in an integrated circuit embedded within the card. These cards are to all intents and purposes impossible to reprogram. As part of the replacement process, the point of sale apparatus used in shops, restaurants etc. need to be replaced. However, these items are expensive and the changeover will not occur over night. During the transition period, the banks and financial institutions will issue cards with both magnetic stripes and chips.

### SUMMARY OF THE INVENTION

According to the present invention, there is provided a card validating apparatus comprising a magnetic stripe reader, a chip card reader for reading data from the chip of a chip card presented to it, indicating means for indicating the validity of a card being validated to a user and processing means configured for comparing data read from a card by the magnetic stripe reader with data read from the card by the chip card reader and operating the indicating means in dependence on the result of said comparison. Thus, the present invention provides vendors with means to take advantage of the security of “chip” cards before integrated chip-reading point of sale apparatus becomes readily and cheaply available. It is to be understood that the signals read from the magnetic stripe and/or those read from the chip may be processed, e.g. for error correction or decryption, before the comparison is made.

The indicating means may conveniently comprise a red light and a green light. The lights may be light-emitting diodes.

Preferably, the apparatus comprises a slot, along which a card can be swiped, and card arresting means for arresting movement of a card in a reading directions along said slot at a predetermined location, wherein the magnetic stripe reader includes a reading head mounted at the side of the slot for reading the magnetic stripe on a card being swiped and the chip card reader comprises contacts at the side of slot for reading data from a card at said predetermined location. The arresting means may comprise a wall blocking an end of the slot.

Preferably, the processing means is configured for recognising a programming chip card from data stored by the card and, in response thereto, storing data read from the card's chip in a predetermined location in a memory.

Preferably, a communications interface is included and the processing means is configured to transmit the data read by the chip card reader by means of the communications interface, after said comparison, irrespective of the result of said comparison.

According to the present invention, there is provided a method of performing a transaction using a financial transaction card having a chip and a magnetic stripe, the method comprising:

reading data from both the chip and the magnetic stripe of said card;

comparing the data read from the chip with the data read from the magnetic stripe;

determining whether there is a predetermined match between the data read from said chip and the data read from said stripe;

generating a perceivable signal in response to the existence of said match; and

responding to said perceivable signal by accepting said card for payment in a transaction.

### BRIEF DESCRIPTION OF THE DRAWINGS

FIG. 1 show a card and a first card validator according to the present invention;

FIG. 2 is a sectional view of the card validator of FIG. 1;

FIG. 3 is a block diagram of the card validator of FIG. 1;

FIG. 4 is a flowchart illustrating the operation of the validator of FIG. 1;

FIG. 5 is a block diagram of second and third card validators according to the present invention;

FIG. 6 is a flowchart illustrating the operation of the second validator and

FIG. 7 is a flowchart illustrating the operation of the third validator.

### DETAILED DESCRIPTION OF THE PREFERRED EMBODIMENTS

Embodiments of the present invention will now be described, by way of example, with reference to the accompanying drawings.

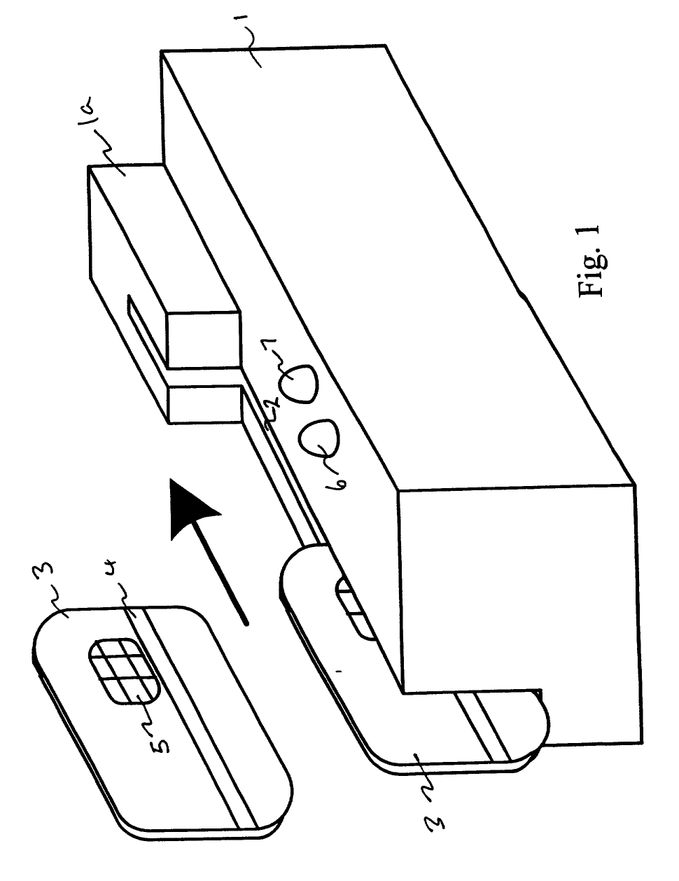

Referring to FIG. 1, a card validator according to the present invention comprises a box-like housing 1 which has a raised portion 1a in one corner. A slot 2 extends down one side of the body 1 and into the raised portion 1a. The slot 2 is blocked off within the raised portion 1a but opens through the opposite end of the body 1. The depth of the slot 2 is such that a card 3 can be held conveniently while it is swiped along the slot 2.

The validator is for validating cards 3 having both a magnetic stripe 4 and an embedded integrated circuit. The same data can be read from both the magnetic stripe 4 and the embedded integrated circuit. The data programmed into the integrated circuit is accessible via electrical contacts 5.

A red light-emitting diode 6 and a green light-emitting diode 7 project through the top of the body 1.

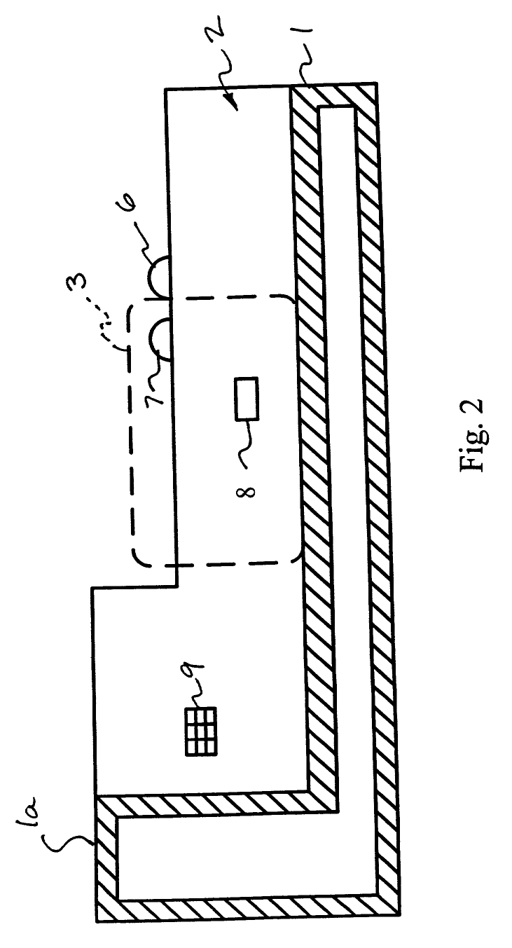

Referring to FIG. 2, a magnetic reading head 8 is mounted in a wall of the slot 2 for reading the data from the magnetic stripe 4 of a card 3 being swiped past. A set of contacts 9 is positioned in the same wall of the slot 2 towards its closed end. The contacts 9 are positioned so that, when a card 3 being swiped is arrested by the closed end of the slot 2, they make contact with respective contacts 5 on the card 3.

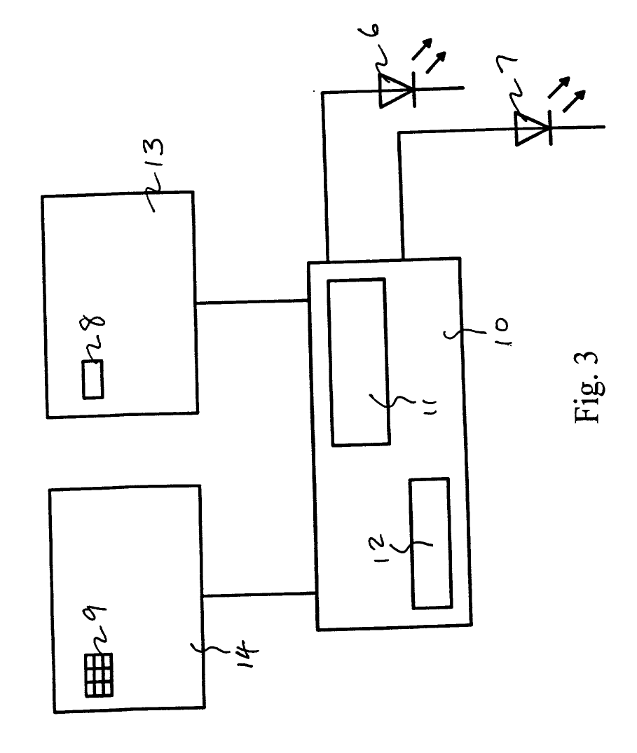

Referring to FIG. 3, the body 1 (FIG. 1) houses processing circuitry 10, including a microprocessor 11 and non-volatile memory 12, a magnetic stripe reader 13, including the head 8, and a chip card interface 14, including the contacts 9. Outputs of the processing circuitry 10 are connected to the red and green light-emitting diodes 6, 7.

In order to perform chip data integrity checks, keys are provided on key programming cards 3. These cards are identified by a characteristic signature recorded in their magnetic stripes.

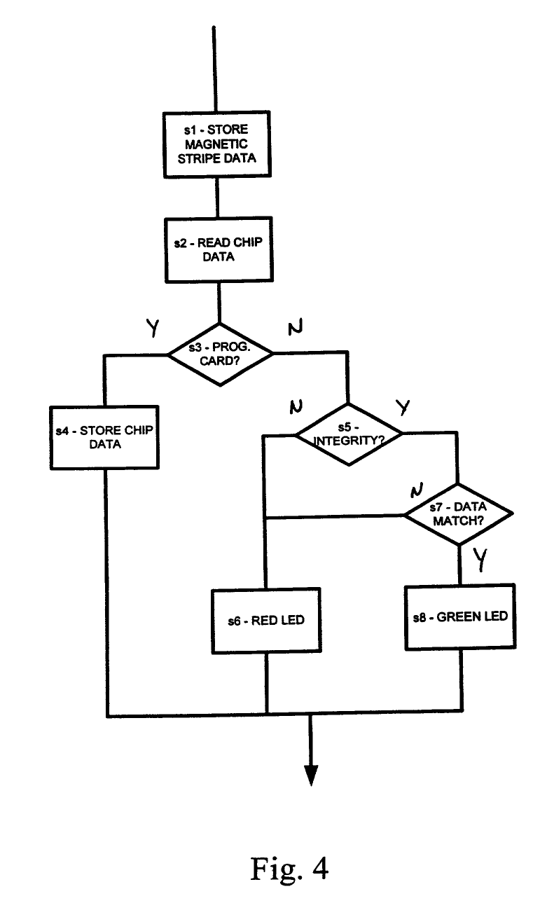

The operation and use of the card validator of FIG. 1 will now be described with reference to FIG. 4.

When a user wishes to validate a card 3 or program in integrity checking keys, the user swipes the relevant card 3 along the slot 2 towards its closed end, i.e. in the direction indicated by the arrow in FIG. 1. As the card 3 passes the head 8, the data recording in its stripe 4 is read by the magnetic stripe reader 13. This data is preceded by twenty ‘0’'s and is followed by a check character. The data read by the magnetic stripe reader 13 is stored by the microprocessor 11 (step s1). As the card 3 reaches the end of the slot 2, its contacts 5 mate with the contacts 9 of the chip card interface 14. The microprocessor 11 reads the data from the chip in the card 3 via the chip card interface 14 (step s2).

If the data from the magnetic strip includes a characteristic signature, the microprocessor 11 recognises the card 3 as a key programming card (step s3). If the card 3 is recognised as a key programming card, the microprocessor 11 simply stores the data read from the card's chip in the non-volatile memory 12 (step s4).

If the card 3 is not a key programming card, the microprocessor 11 performs an integrity check (step s5) on the data from the card's chip using a key from the nonvolatile memory 12. If the data fails the integrity check, the microprocessor 11 causes the red light-emitting diode 6 to light up (step s6). If, however, the integrity check is passed, the microprocessor 11 compares the data from the chip (step s7), which corresponds to data recorded in the magnetic stripe 4, with the data read from the magnetic stripe 4. If the data from the two sources match, the microprocessor 11 causes the green light-emitting diode 7 to light up (step s8), otherwise the microprocessor 11 causes the red light-emitting diode to light up (step s6).

If the green light-emitting diode 7 lights up, the user knows that it is safe to perform a transaction and pass the card 3 through the conventional card-reading transaction terminal or take an impression of the card 3. However, if the red light-emitting diode 6 lights up, the user know that the card has been tampered with or damaged and should be rejected.

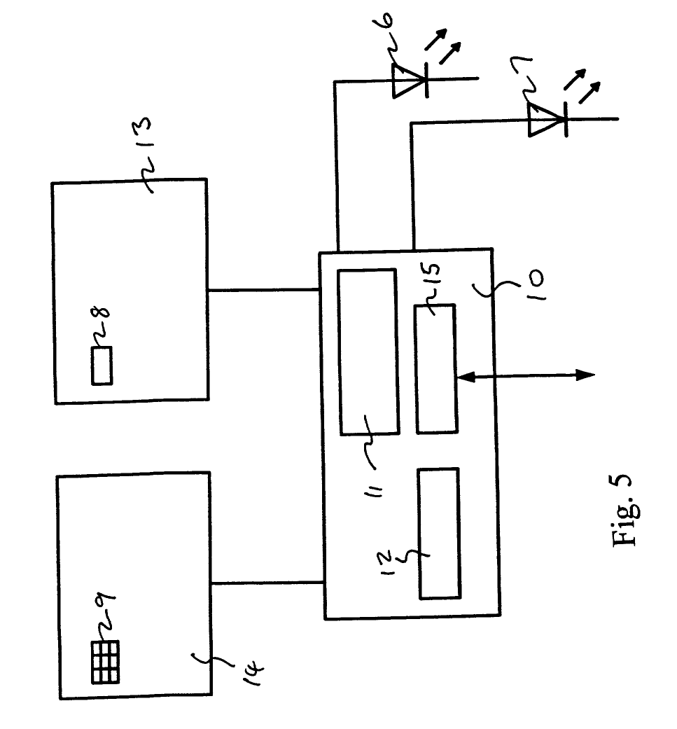

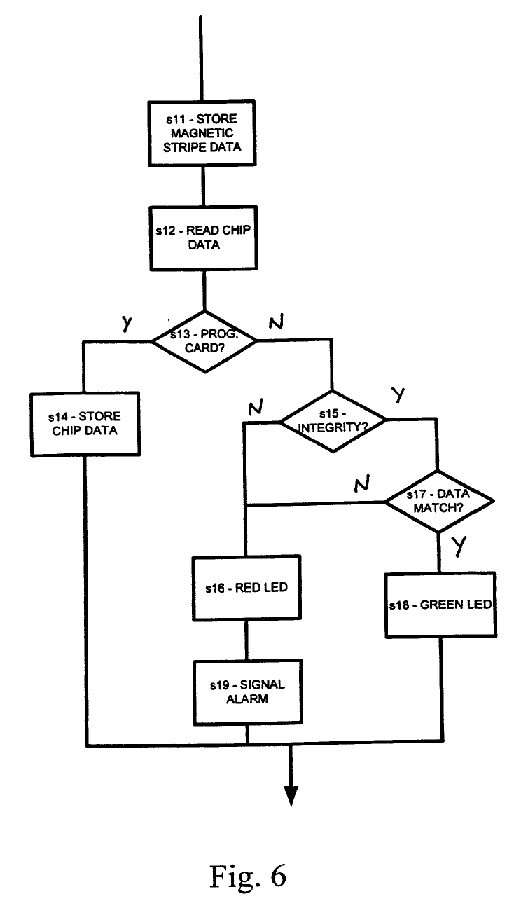

Referring to FIGS. 5 and 6, in a second embodiment, the processing circuitry 10 includes a communications interface 15. The microprocessor 11 is programmed so that the validator operates as described above with reference to FIG. 4 (steps s11 to s18) except that in an additional step s19 (FIG. 6) an alarm signal is transmitted to a remote location, e.g. to security staff, using the communications interface when a card 3 fails the data integrity test or the data comparison test.

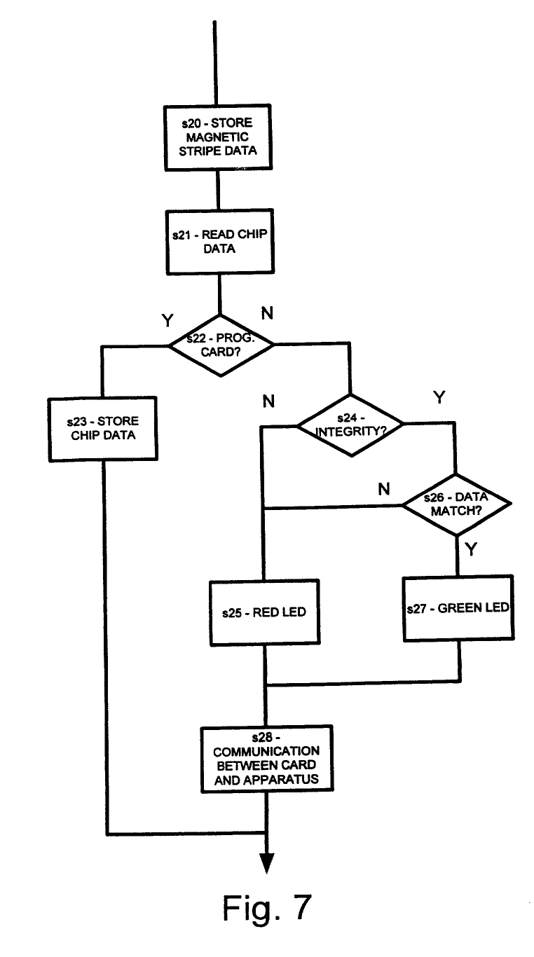

Referring again to FIG. 5 and to FIG. 7, in a third embodiment, the microprocessor 11 is programmed so that the validator operates as described above with reference to FIG. 4 (steps s20 to s27) except that data read from the card's chip is communicated between the chip in a card 3 and a computer-based point-of-sale apparatus via the communications interface 15 (step s28) after a card has been validated. It should be noted that the data transmitted to the point of sale terminal is the data read from the card's chip not the result of the validation process. Consequently, the user can use the card validator as a chip card interface when the chip card processing infrastructure becomes available for the user and cards no longer have magnetic stripes.

In the second and third embodiments, the communications interface 15 may also be used for loading integrity check keys.

It will be appreciated that many modifications may be made to the embodiments described above. For instance, key programming cards may be identified by data stored in their chips.

What is claimed is:

1. A card validating apparatus comprising:
a magnetic stripe reader;
a chip card reader for reading data from the chip of a chip card presented to it;
an indicator for indicating the validity of a card being validated to a user; and
a processor configured for comparing data read from a card by the magnetic stripe reader with data read from the card by the chip card reader and operating the indicator in dependence on the result of said comparison.

2. An apparatus according to claim 1, wherein the indicator comprises a red light and a green light.

3. An apparatus according to claim 1, comprising a slot and card arresting means for arresting movement of a card in a reading directions along said slot at a predetermined location, wherein the magnetic stripe reader includes a reading head mounted at the side of the slot and the chip card reader comprises contacts at the side of slot for reading data from a card at said predetermined location.

4. An apparatus according to claim 3, wherein the arresting means comprises a wall blocking an end of the slot.

5. An apparatus according to claim 1, wherein the processor is configured for recognising a programming chip card from data stored by the card and, in response thereto, storing data read from a chip in a predetermined location in a memory.

6. An apparatus according to claim 1, including a communications interface, wherein the processor is configured to transmit the data read by the chip card reader by means of the communications interface, after said comparison, irrespective of the result of said comparison.

7. A method of performing a transaction using a financial transaction card having a chip and a magnetic stripe, the method comprising:
receiving a financial transaction card having a chip and a magnetic stripe;
reading data from both the chip and the magnetic stripe of said card;
comparing the data read from the chip with the data read from the magnetic stripe;
determining whether there is a predetermined match between the data read from said chip and the data read from said stripe;
generating a perceivable signal in response to the existence of said match; and
responding to said perceivable signal by accepting said card for payment in a transaction.
